(19) United States
(12) Patent Application Publication
(10) Pub. No.: US 2023/0184620 A1
(43) Pub. Date: Jun. 15, 2023

(54) Method for characterising leaks

(71) Applicant: VEOLIA ENVIRONNEMENT, PARIS (FR)

(72) Inventors: Yves-Marie BATANY, PARIS (FR); Damien CHENU, ASNIERES-SUR-SEINE (FR); Nicolas ROUX, LA GARENNE-COLOMBES (FR)

(21) Appl. No.: 18/012,692

(22) PCT Filed: Jul. 15, 2021
(86) PCT No.: PCT/FR2021/051318

§ 371 Date: Dec. 23, 2022

(30) Foreign Application Priority Data
Jul. 15, 2020 (FR) FR2007434

(51) Int. Cl. G01M 3/24; G01M 3/28; G06N 20/00

(52) U.S. Cl. CPC G01M 3/243; G01M 3/2807; G06N 20/00

(57) ABSTRACT

A method for characterizing a leak in a fluid network, making it possible to determine the type and/or the flow rate of a leak in a fluid network, in which the fluid network is equipped with a plurality of vibro-acoustic sensors configured to provide vibro-acoustic signals, and in which a statistical learning model receives as input at least one vibro-acoustic signal obtained directly or indirectly from at least one vibro-acoustic sensor and provides as output at least one leak characterization data among the leak type and the leak flow rate.

### TECHNICAL FIELD

The present disclosure relates to a method for characterizing a leak in a fluid network, making it possible to characterize the severity of a leak in a fluid network by determining its type and/or its flow rate.

Such a method can be used in particular to characterize leaks within a water distribution network. However, it could also be used for gas, fuel networks or any other fluid, liquid or gaseous network. Such a method can also be applied to different sizes of networks.

### BACKGROUND

In France, the drinking water distribution networks present losses of about 20% on the national territory with sometimes losses that can locally reach nearly 40%. Other countries are experiencing even more worrying situations with local losses of up to 60%.

It is therefore essential to be able to detect and characterize the leaks present in a water distribution network in order to be able to prioritize the interventions and repair the thus detected leaks.

Several techniques exist so far in order to perform such detection. Among them, the vibro-acoustic listening and sectorization methods are the most widely used.

The vibro-acoustic listening methods aim at locally listening, using a microphone for example, to the signals emitted by the leaks in the pipes. Such a technique is quite effective but it requires a large number of listening points, that is to say a large number of sensors or, in the case of a mobile configuration, a full-time expert operator moving along the network, in order to cover the entire network. In addition, they are highly subject to acoustic disturbances from the environment of the pipes, for example road traffic. Finally, and especially, these methods allow locating the leaks but they do not allow characterizing them.

The sectorization methods for their part aim at sectorizing the network into small isolated areas and comparing the flow rates at the inlet and at the outlet of each area in order to detect the presence of a leak flow rate. However, such a method is not sufficient on its own since it does not allow locating quite precisely the location of the leak, particularly on a mesh network that would require too many sensors. In addition, the sectorization does not allow discriminating the severity of each leak when several leaks are present in the same sector. In any case, when an estimation of the severity is possible, this estimation can only be obtained a posteriori, after the repair of the leak, which prevents any prioritized maintenance.

In addition, such a water distribution network frequently presents multiple leaks of various types and severities. Particularly, the repair of some minor leaks is not always profitable or at least not always a priority. However, the current detection methods, and particularly the acoustic listening methods, do not allow obtaining precise information as to the severity of the detected leak, which makes it difficult to set up a prioritized maintenance.

There is therefore a real need for a method for characterizing a leak in a fluid network, making it possible to determine the type and/or the flow rate of a leak before its repair and which is at least partly devoid of the drawbacks inherent in the aforementioned known methods.

### DETAILED DESCRIPTION

The present disclosure relates to a method for training a statistical learning model intended for the characterization of a leak in a fluid network, in which the fluid network is equipped with a plurality of vibro-acoustic sensors configured to provide vibro-acoustic signals, including the construction of a database associating, at least for a plurality of documented leaks, at least one leak characterization data actually determined among the leak type and the leak flow rate with at least one vibro-acoustic signal obtained directly or indirectly from at least one vibro-acoustic sensor, and including the training of the statistical learning model on the thus constructed database.

Thanks to such a method, it is possible to build a database that will allow the statistical learning model, once trained on this database, to characterize a leak in a fluid network based on one or several vibro-acoustic signals obtained on the fluid network in question.

Naturally, the more the database contains a large number of documented leaks, the more the training of the statistical learning model will be advanced and the more this statistical learning model will be capable of characterizing the leaks detected accurately.

In the present disclosure, by “vibro-acoustic sensor” it is meant a sensor coupled to any type of liquid or solid medium and capable of recording a displacement, a speed, an acceleration or a higher-order time derivative in one or several directions, and in particular in the three spacial directions. It can therefore be in particular an accelerometer, a seismometer, a geophone, a microphone or a hydrophone, to mention but a few. These may be permanently mounted sensors and/or mobile sensors temporarily applied by an operator.

In some embodiments, the fluid network is provided with a digital mapping including at least the geometry of the fluid network and the location of the vibro-acoustic sensors. This digital mapping can conform to the real mapping or include simulated map elements. These simulated map elements allow completing the digital mapping when some elements of the real mapping are unknown. These simulated map elements can also allow simulating alternative scenarios by replacing a real map element with a simulated map element, for example by virtually modifying the diameter of a pipe or by simulating fictitious pipes in the extension of the existing network.

In some embodiments, the training method includes, for at least one documented leak, a step of measuring the leak flow rate. Particularly, this leak flow rate can be obtained by a direct measurement at the level of the leak. Such a measurement can be in particular performed by an operator just before repairing the leak.

In some embodiments, the fluid network is equipped with at least one flow rate sensor providing sectorization data. These sectorization data can also include pressure measurements performed by at least one pressure sensor. The location of these sectorization sensors can be recorded in the digital mapping of the network.

In some embodiments, the training method includes, for at least one documented leak, a step of determining the leak flow rate using the sectorization data. For some leaks, as a function of their number, their location and the number of nearby flowmeters, this determination can be made directly, during the presence of the leak. For other leaks, if this direct determination is not possible, the determination can be made indirectly, for example by comparing the sectorization data before and after the repair of the leak. Such a determination step makes superfluous the direct measurement of the leak flow rate performed by an operator at the level of the leak. Consequently, it is possible to include minor leaks in the database for which a repair is not considered as a priority.

In some embodiments, for at least one documented leak, the determination step is carried out automatically by comparing the sectorization data before and after the repair of the leak in question.

In some embodiments, the database includes, for at least one documented leak, vibro-acoustic signals recorded by at least some vibro-acoustic sensors of the fluid network. Preferably, each signal is recorded in the database in association with the identification and/or the location of the vibro-acoustic sensor at the origin of the signal. For a documented leak, a plurality of signals are thus associated in the database, which increases the size of the database and therefore enhances the training of the statistical learning model. In addition, signals that have undergone attenuations and/or alterations during their propagation along the fluid network are associated, which helps the statistical learning model characterize a leak even in the event of attenuation and/or alteration of the vibro-acoustic signals. Indeed, any physical element constituting a pipe network can affect the propagation of the waves and thus cause alterations of the signals.

In some embodiments, the training method includes, for at least one documented leak, a step of simulating at least one virtual vibro-acoustic sensor having a virtual location recorded in the digital mapping of the fluid network and a simulated vibro-acoustic signal from the actually measured vibro-acoustic signals by real vibro-acoustic sensors and the geometric data from the digital mapping of the fluid network. Thanks to such a simulation step, it is possible to artificially increase the number of signals available for the training of the statistical learning model while keeping a reasonable number of real sensors within the fluid network. The training of the statistical learning model is thus enhanced without the extra cost of additional equipment. Such a simulated vibro-acoustic signal can be in particular obtained by digital simulation. Particularly, such a simulation can rely on the use of transfer functions associated with each element of the fluid network.

In some embodiments, the step of simulating at least one virtual vibro-acoustic sensor is based on the real mapping of the network.

In some embodiments, the step of simulating at least one virtual vibro-acoustic sensor is based on a simulated mapping including at least one simulated map element. Particularly, this simulated mapping can include at least one fictitious pipe. In this way, it is for example possible to continue to propagate a vibro-acoustic signal in a network of fictitious pipes extending beyond the existing network and therefore to simulate an even larger number of virtual vibro-acoustic sensors, at even greater distances from the documented leak. Thus, the size of the database is further increased, which further enhances the training of the statistical learning model.

In some embodiments, the number of virtual vibro-acoustic sensors is at least twice greater than the number of real vibro-acoustic sensors.

In some embodiments, the training method includes a step of locating the leak from the vibro-acoustic signals from the vibro-acoustic sensors and the geometric data from the digital mapping of the fluid network. The information regarding the location of the leak is thus obtained, which allows, if necessary, sending a maintenance agent directly to the right address in order to characterize and/or repair the leak.

In some embodiments, the database includes, for at least one documented leak, the vibro-acoustic signal actually recorded in the vicinity of the leak. The vibro-acoustic signal recorded during the leak, that is to say before any attenuation or any alteration due to its propagation along the fluid network, is thus associated for each documented leak: such a signal thus constitutes a primary signature of the leak, particularly useful for training the statistical learning model. This signal during the leak can be in particular recorded by a maintenance agent just before the repair of the leak. Depending on the accessibility of the leak, this signal will be measured within 50 m of the leak, preferably within 10 m of the leak, preferably within 1 m of the leak.

In some embodiments, the training method includes, for at least one documented leak, a step of reconstructing the vibro-acoustic signal at the level of the leak from the vibro-acoustic signals from the vibro-acoustic sensors and the geometric data from the digital mapping of the fluid network. This is another method for obtaining an approximation of the vibro-acoustic signal during the leak, in particular when it is not possible or desirable to record the real signal directly at the level of leak. Thus, the vibro-acoustic signal reconstructed during the leak, that it to say before any attenuation or any alteration due to its propagation along the fluid network is associated for each documented leak: such a signal thus constitutes a primary signature of the leak, particularly useful for the training of the statistical learning model. Such a signal reconstructed during the leak can be in particular obtained by the simulation of a virtual sensor at the level or in the vicinity of the leak.

In some embodiments, the training method includes at least one leak generation step during which a leak is artificially caused within the fluid network. This allows increasing the number of leaks documented within the database, and thus enhancing the training of the statistical learning model, by controlling the parameters of the thus generated leak. Such an artificial leak can be in particular caused by using structures of the valve or fire hydrant type.

In some embodiments, the training method includes, for at least one documented leak, a noise-adding step during which noise is added to at least one actually measured vibro-acoustic signal. Such noise addition makes the training of the statistical learning model more robust. The added noise can in particular include conventional colored noises, white or pink for example, and/or noises specific to water networks, such as the noise of a passing car, of a running mechanical counter or of people talking nearby, to mention but a few.

In some embodiments, the database includes, for at least one documented leak, structural data of the pipe at the level of the leak. These structural data can in particular include the material of the pipe, its nominal diameter, its thickness, its depth or the surrounding ground material or the backfill type. These data are useful to help the statistical learning model take into account the signal variations that may appear for a leak of given type and flow rate as a function of the physical properties of the pipe having the leak. In this way, it will be easier for the statistical learning model to characterize the leaks if these additional contextual variables are given thereto.

In some embodiments, the database includes, for at least one documented leak, contextual repair data among the type of backfill used, the flooding state around the leak and/or a photograph of the leak. These data can be used in particular for the training of the statistical learning model.

In some embodiments, the database includes data from documented leaks of a single fluid network. The statistical learning model is then specialized in the characterization of the leaks of this particular fluid network; it nevertheless remains able to characterize the leaks of other fluid networks if necessary, with lower accuracy.

In some embodiments, the database includes data from documented leaks of several fluid networks. The size of the database is thus increased, which enhances the training of the statistical learning model. Greater weight can however be given to the documented leaks of a particular fluid network when the statistical learning model is intended to be applied to that particular fluid network.

In some embodiments, at least some vibro-acoustic sensors are correlating sensors directly or indirectly sharing a common clock. Such sensors allow tracking the propagation of a sound wave or a vibratory signal, along the fluid network. Thus, thanks to such sensors, it is possible to estimate the distance separating the sensor from the leak and therefore, using several sensors, to determine the position of the leak.

In some embodiments, at least one vibro-acoustic sensor is provided at least every 200 m, preferably at least every 100 m, more preferably at least every 50 m, along the fluid network. The finer the mesh, the greater the probability of having a large number of sensors in the vicinity of the leak, and therefore of having a large number of operable signals. Consequently, the finer the mesh, the more different signals the database includes for a given leak and therefore the more efficient the training of the statistical learning model. In addition, the distance between sensors can be modulated as a function of the type of material making up the pipe; particularly a finer mesh is preferable for the plastic networks.

In some embodiments, at least one sensor is installed at a valve box of the fluid network. The sensor can in particular include a measuring head located at the bottom of the extension tube, in contact with the pipe. However, of course, this is only one example of an installation among many envisageable options. Particularly, the sensors can be mounted on or within any element of the network.

In some embodiments, the training method includes a standardization step resulting in converting the raw vibro-acoustic signal from at least one vibro-acoustic sensor into a standardized vibro-acoustic signal having a predetermined format. Such a step allows in particular using different types or models of sensors and converting all the raw signals into the same format, which allows the statistical learning model to work on the standardized signals, independently of the sensor type or model actually used. Particularly, this standardization step can use transfer functions, determined theoretically or empirically, for each sensor type or model used. This step can also artificially introduce a loss of quality compared to the raw vibro-acoustic signal. It is thus possible to simulate the defects of some sensors, which allows improving the training of the statistical learning model. It is for example possible to simulate a lossy compression. This standardization of the signal can be in particular a compression, a spectral aliasing or other signal processing techniques.

In some embodiments, the predetermined common format of the standardized vibro-acoustic signals is a sound format, for example of the WAVE type.

In some embodiments, the training method includes a pre-processing step resulting in qualifying and cleaning the vibro-acoustic signal from at least one vibro-acoustic sensor. This step allows in particular checking whether the signal is not corrupted or polluted by a noise covering the signal, such as a passing vehicle for example, and therefore whether the signal is operable by the statistical learning model. It also allows cleaning the signal of any interference using one or several filters.

In some embodiments, the training method includes a step of transforming the representation of the vibro-acoustic signals into other mathematical spaces.

In some embodiments, the training method includes a decomposition step resulting in decomposing the vibro-acoustic signal from at least one vibro-acoustic sensor. This can be in particular a Fourier decomposition. The result of this decomposition can be recorded in the database and can be used for the training of the statistical learning model.

In some embodiments, the digital mapping of the fluid network includes location data for the valves and/or other equipment. In this way, it is possible to predict and take into account the alterations of the vibro-acoustic signals during their propagation through this equipment. The accuracy of the signal simulations and/or the reconstructions is thus increased. Particularly, a transfer function can be associated with each type of equipment.

In some embodiments, the digital mapping of the fluid network includes structural data of the fluid network. These structural data can in particular include the material of each pipe, its nominal diameter, its thickness, its depth or the surrounding ground material or the backfill type. These data are useful for increasing the accuracy of the signal simulations and/or reconstructions within the fluid network. They can also be used to help the statistical learning model take into account the signal variations that may appear for a leak of a given type and flow rate as a function of the physical properties of the pipe carrying a given vibro-acoustic sensor. In this way, it will be easier for the statistical learning model to characterize the leaks if these additional contextual variables are given thereto.

In some embodiments, the type of leak is determined at least among three different types, preferably at least among five different types. Particularly, the type of leak can be determined among the following types: leak on duct, duct break, leak on duct tapping, leak on connections, leak on collar, fire hydrant leak, leak after meter, leak on seal, leak on valve, leak on suction cup, leak on flange, leak on cable gland, leak on another nearby network (e.g. sanitation, gas, etc.), to mention but a few.

In some embodiments, the database also includes data, particularly vibro-acoustic signals, corresponding to leak-free scenarios. Thanks to such leak-free scenarios, the possibility for the statistical learning model, once trained, to conclude that there is no leak when no leak is present in the network, is introduced.

In some embodiments, the statistical learning model is of the classifier type. In other words, the leak flow rate is determined among predetermined flow rate ranges. These ranges can have constant or variable widths. Preferably, the width of each range is less than or equal to 10 m³/h, more preferably less than or equal to 5 m³/h.

In some embodiments, the statistical learning model is of the regressor type. In other words, the leak flow rate is determined as accurately as possible, with a certain margin of error. Preferably, this margin of error is less than or equal to 10% or less than or equal to 10 m³/h or 5 m³/h. In some embodiments, the fluid network is a water network. It is preferably a charging drinking water distribution network.

In some embodiments, the statistical learning model is a neural network.

In some embodiments, the neural network is of the convolutional type with preferably at least two convolutional layers of time filters applied on the vibratory signals and at least two non-convolutional layers. The non-convolutional layers can be applied to the results of the convolutional layers and/or to the contextual data.

In some embodiments, the convolutional layers of the neural network contain time filters of a size between 25 and 100 ms applied on the vibratory signals. The convolutional layers are organized such that the number of filters increases with each layer. The simple layers are organized such that the number of neurons can decrease until the final estimation. To avoid the overlearning, the abandonment technique can be used between 30 and 70%. To obtain an estimation of uncertainty, a Bayesian network can be used.

In some embodiments, the statistical learning model is a random forest, a support vector machine or a non-linear regression.

The present disclosure also relates to a method for characterizing a leak in a fluid network, in which the fluid network is equipped with a plurality of vibro-acoustic sensors configured to provide vibro-acoustic signals, and in which a statistical learning model receives as input at least one vibro-acoustic signal obtained directly or indirectly from at least one vibro-acoustic sensor and provides as output at least one leak characterization data among the leak type and the leak flow rate.

Thus, thanks to such a statistical learning model, it is possible to obtain information on the type and/or the flow rate, that is to say the severity, of the leak without investing significant resources in the hydraulic instruments of the fluid network. In addition, this estimation can be done remotely. The characterization method is also capable of concluding that there is no leak if, during the analysis of the signals, the statistical learning model does not detect any leak.

Consequently, thanks to such a method, it is possible to prioritize the repairs to be conducted within the fluid network, which optimizes maintenance costs and therefore increases the overall performance of the fluid network.

In some embodiments, the statistical learning model receives as input the vibro-acoustic signals from several vibro-acoustic sensors. Particularly, the statistical learning model can receive the signals from all the vibro-acoustic sensors of the fluid network or from only some of them, for example the sensors closest to the leak or those providing a signal having a level and/or a quality above a certain threshold.

In some embodiments, the fluid network is provided with a digital mapping including at least the geometry of the fluid network and the location of the vibro-acoustic sensors. This digital mapping can conform to the real mapping or include simulated map elements. These simulated map elements allow completing the digital mapping when some elements of the real mapping are unknown. These simulated map elements can also allow simulating alternative scenarios by replacing a real map element with a simulated map element, for example by virtually modifying the diameter of a pipe or by simulating fictitious pipes in the extension of the existing network.

In some embodiments, the characterization method includes a step of simulating at least one virtual vibro-acoustic sensor having a virtual location recorded in the digital mapping of the fluid network and a simulated vibro-acoustic signal from vibro-acoustic signals from the real vibro-acoustic sensors and the geometric data from the digital mapping of the fluid network. Such a simulated vibro-acoustic signal can be in particular obtained by digital simulation of the acoustic propagation. Particularly, such a resolution can rely on the use of transfer functions, determined for example using laboratory tests or in real conditions, associated with each element of the fluid network.

In some embodiments, the neural network receives as input at least one simulated vibro-acoustic signal.

In some embodiments, the step of simulating at least one virtual vibro-acoustic sensor is based on the real mapping of the network.

In some embodiments, the step of simulating at least one virtual vibro-acoustic sensor is based on a simulated mapping including at least one simulated map element. Particularly, this simulated mapping can include at least one fictitious pipe.

In some embodiments, the number of virtual vibro-acoustic sensors is at least twice the number of real vibro-acoustic sensors.

In some embodiments, the characterization method includes a step of locating the leak from the vibro-acoustic signals from the vibro-acoustic sensors and the geometric data from the digital mapping of the fluid network. The information regarding the location of the leak is thus obtained, which allows, if necessary, sending a maintenance agent directly to the right address in order to repair the leak. The location of the leak can also be taken into account in the evaluation of the priority to repair this leak.

In some embodiments, the characterization method includes a step of reconstructing the vibro-acoustic signal at the level of the leak from the vibro-acoustic signals from the vibro-acoustic sensors and the geometric data from the digital mapping of the fluid network. An approximation of the vibro-acoustic signal generated at the level of the leak is thus obtained, that is to say before any attenuation or any alteration due to its propagation along the fluid network: such a signal, constituting a primary signature of the leak, brings a significant amount of information to the statistical learning model, which facilitates the characterization. Such a signal to the source can be in particular obtained by digital simulation of the acoustic propagation. Particularly, such a resolution can rely on the use of transfer functions associated with each element of the fluid network. Such a signal reconstructed during the leak can be in particular obtained by the simulation of a virtual sensor at the level or in the vicinity of the leak.

In some embodiments, the statistical learning model receives as input at least the vibro-acoustic signal reconstructed at the level of the leak.

In some embodiments, at least some vibro-acoustic sensors are correlating sensors directly or indirectly sharing a common clock. Such sensors allow tracking the propagation of a sound wave or a vibratory signal along the fluid network. Thus, thanks to such sensors, it is possible to estimate the distance separating the sensor from the leak and therefore, using several sensors, to determine the position of the leak.

In some embodiments, at least one vibro-acoustic sensor is provided at least every 200 m, preferably at least every 100 m, more preferably at least every 50 m, along the fluid network. The finer the mesh, the greater the probability of having a large number of sensors in the vicinity of the leak, and therefore of having a large number of operable signals. Consequently, the finer the mesh, the more different signals the database includes for a given leak and therefore the more efficient the training of the statistical learning model. In addition, the distance between sensors can be modulated as a function of the type of material making up the pipe; particularly a finer mesh is preferable for the plastic networks.

In some embodiments, at least one sensor is installed at a valve box of the fluid network. The sensor can in particular include a measuring head located at the bottom of the extension tube, in contact with the pipe. However, of course, this is only one example of installation among many envisageable options. Particularly, the sensors can be mounted on or within any element of the network.

In some embodiments, the characterization method includes a standardization step resulting in converting the raw vibro-acoustic signal from at least one vibro-acoustic sensor into a standardized vibro-acoustic signal having a predetermined format. Such a step allows in particular using different types or models of sensors and converting all the raw signals into the same format, which allows the statistical learning model to work on the standardized signals, independently of the sensor type or model actually used. Particularly, this standardization step can use transfer functions, determined theoretically or empirically, for each sensor type or model used.

In some embodiments, the predetermined common format of the standardized vibro-acoustic signals is a sound format, for example of the WAVE type.

In some embodiments, the characterization method includes a pre-processing step resulting in qualifying and cleaning the vibro-acoustic signal from at least one vibro-acoustic sensor. This step allows in particular checking whether the signal is not corrupted or polluted by a noise covering the signal, such as a passing vehicle for example, and therefore whether the signal is operable by the statistical learning model. It also allows cleaning the signal of any interference using one or several filters.

In some embodiments, the characterization method includes a step of transforming the representation of the vibro-acoustic signals into other mathematical spaces.

In some embodiments, the characterization method includes a decomposition step resulting in decomposing the vibro-acoustic signal from at least one vibro-acoustic sensor. This can be in particular a Fourier decomposition. The result of this decomposition can be provided at the inlet of the statistical learning model, instead of or in addition to the original signal. This can facilitate the characterization by the statistical learning model.

In some embodiments, the digital mapping of the fluid network includes location data for the valves and/or other equipment. In this way, it is possible to predict and take into account the alterations of the vibro-acoustic signals during their propagation through this equipment. The accuracy of the signal simulations and/or reconstructions is thus increased. Particularly, a transfer function can be associated with each type of equipment.

In some embodiments, the digital mapping of the fluid network includes structural data of the fluid network. These structural data can in particular include the material of the pipe, its nominal diameter, its thickness, its depth or the surrounding material. These data are useful to help the statistical learning model take into account the signal variations that may appear for a leak of a given type and flow rate as a function of the physical properties of the pipe having the leak. In this way, it is easier for the statistical learning model to characterize the leaks, regardless of the size or material of the pipes involved.

In some embodiments, the type of leak is determined at least among three different types, preferably at least among five different types. Particularly, the type of leak can be determined among the following types: leak on duct, duct break, leak on duct tapping, leak on connections, leak on collar, fire hydrant leak, leak after meter, leak on seal, leak on valve, leak on suction cup, leak on flange, leak on cable gland, leak on another nearby network (e.g. sanitation, gas, etc.), to mention but a few.

In some embodiments, the statistical learning model is of the classifier type. In other words, the leak flow rate is determined among predetermined flow rate ranges. These ranges can have constant or variable widths. Preferably, the width of each range is less than or equal to 10 m³/h, more preferably less than or equal to 5 m³/h.

In some embodiments, the statistical learning model is of the regressor type. In other words, the leak flow rate is determined as accurately as possible, with a certain margin of error. Preferably, this margin of error is less than or equal to 10% or less than or equal to 10 m³/h or 5 m³/h.

In some embodiments, the fluid network is a water network. It is preferably a charging drinking water distribution network.

In some embodiments, the neural network is of the convolutional type with preferably at least two convolutional layers of time filters applied on the vibratory signals and at least two non-convolutional layers. The non-convolutional layers can be applied to the results of the convolutional layers and/or to the contextual data.

In some embodiments, the convolutional layers of the neural network contain time filters of a size between 25 and 100 ms applied on the vibrational signals. The convolutional layers are organized such that the number of filters increases with each layer. The simple layers are organized such that the number of neurons can decrease until the final estimation. To avoid the overlearning, the abandonment technique can be used between 30 and 70%. To obtain an estimation of uncertainty, a Bayesian network can be used.

In some embodiments, the statistical learning model is a random forest, a support vector machine or a non-linear regression.

In some embodiments, the statistical learning model has been trained using a training method according to any one of the embodiments described above.

In some embodiments, the characterization method includes a verification step during which the type and/or flow rate of the leak characterized by the statistical learning model is actually verified and then recorded in the database in order to complete the training of the statistical learning model.

The present disclosure also relates to a module for characterizing a leak in a fluid network, the fluid network being equipped with a plurality of vibro-acoustic sensors configured to provide vibro-acoustic signals including a statistical learning model configured to receive as input at least one vibro-acoustic signal obtained directly or indirectly from at least one vibro-acoustic sensor and to provide as output at least one leak characterization data among the leak type and the leak flow rate.

The advantages of this characterization module stem from the advantages described above for the characterization method. In addition, this characterization module can present all or part of the additional characterizations described above concerning the training method and/or the characterization method.

The present disclosure also relates to a fluid network, including a plurality of vibro-acoustic sensors configured to provide vibro-acoustic signals, and a characterization module according to any one of the preceding embodiments.

The present disclosure also relates to a computer program including instructions for executing the steps of the training method or of the characterization method described above when the program is executed by a computer.

The aforementioned characteristics and advantages, as well as others, will become apparent upon reading the following detailed description of exemplary embodiments of the proposed training method, characterization method and characterization module. This detailed description refers to the appended drawings.

### BRIEF DESCRIPTION OF THE DRAWINGS

The appended drawings are schematic and primarily intended to illustrate the principles of the disclosure.

In these drawings, from one figure to another, identical elements (or parts of elements) are identified by the same reference signs. Furthermore, elements (or parts of elements) belonging to different exemplary embodiments but having a similar function are identified in the figures through numerical references incremented by 100, 200, etc.

FIG. 1 is an overall diagram of a fluid network equipped with a leak characterization module.

FIG. 2 is an overview diagram of a leak characterization module.

FIG. 3 illustrates the detection of a leak within the fluid network of FIG. 1.

FIG. 4 illustrates the acquisition of the vibro-acoustic signal at the level of the leak.

FIG. 5 illustrates a first example of a neural network training.

FIG. 6 illustrates a first example of a leak characterization using this neural network.

FIG. 7 illustrates the simulation of virtual vibro-acoustic sensors.

FIG. 8 illustrates a second example of a neural network training.

FIG. 9 illustrates a second example of a leak characterization using this neural network.

### DESCRIPTION OF THE EMBODIMENTS

In order to make the disclosure more concrete, examples of training methods, characterization methods and characterization modules are described in detail below, with reference to the appended drawings. It is recalled that the disclosure is not limited to these examples.

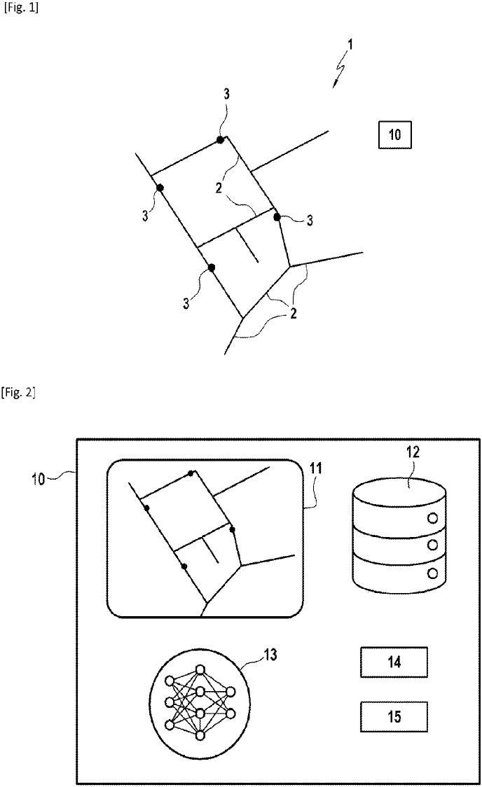

FIG. 1 represents a fluid network diagram 1, in this case a drinking water distribution network. This fluid network 1 has a plurality of pipes 2 on which a plurality of vibro-acoustic sensors 3, here acoustic sensors of the accelerometer type, are mounted. The fluid network also has a leak characterization module 10 which can be hosted within a computer of the management of the fluid network 1 or within a remote server. The fluid network 1 further includes sectorization sensors, and particularly flowmeters and pressure gauges.

FIG. 2 illustrates the main elements of this leak characterization module 10. It thus includes a digital mapping 11 of the fluid network 1, a leak database 12, a neural network 13 (forming a statistical learning model), a calculation unit 14 and a memory 15; it also includes all the electronic elements that allow operating such an electronic module: power supply, user interfaces, etc.

The digital map 11 includes the geometry of the fluid network 1, that is to say the position, the orientation and the length of all the pipes 2, as well as the position of the whole equipment of the network, that is to say the valves, the junction collars, the connections, the valve boxes etc. The digital map 11 further includes the location of all the vibro-acoustic sensors 3 but also of the sectorization sensors.

The digital map 11 also includes the most comprehensive structural data for the entire network 1, and in particular, as much as possible, the material of each pipe, its nominal diameter, its thickness, its depth or the surrounding ground material.

The database 12 for its part compiles as much data as possible concerning the leaks identified and characterized in the past within the fluid network 1. Its construction will be described in more detail below.

In the present example, the neural network 13 is a convolutional network of the regressor type including two convolutional layers of time filters and two non-convolutional layers. The layers of the neural network 13 contain time filters of a size between 25 and 100 ms. The convolutional layers are organized such that the number of filters increases with each layer. The single layers are organized such that the number of neurons decreases until the final estimation. To avoid the overlearning, the abandonment technique is used between 30 and 70%. In addition, to obtain an estimation of uncertainty, a Bayesian network is used.

The calculation unit 14 can in particular take the form of a processor: it is in particular programmed to be capable of solving digital problems of propagation of a sound wave along the fluid network 1, based on the geometric and structural data from the digital mapping 11.

The memory 15 can take any form of data storage. It includes in particular the theoretical equations of the propagation of the sound waves along a pipe. It also includes a library of transfer functions, established theoretically or empirically using laboratory or on-site tests, making it possible to simulate the deformation undergone by a vibro-acoustic signal during its passage through a particular equipment of the fluid network 1, particularly a valve, a bend, a connection or a collar. This library also includes transfer functions for converting the raw signal from a vibro-acoustic sensor of a given type and model into a common reference format of the sound wave type, for example in the form of a WAVE type sound file.

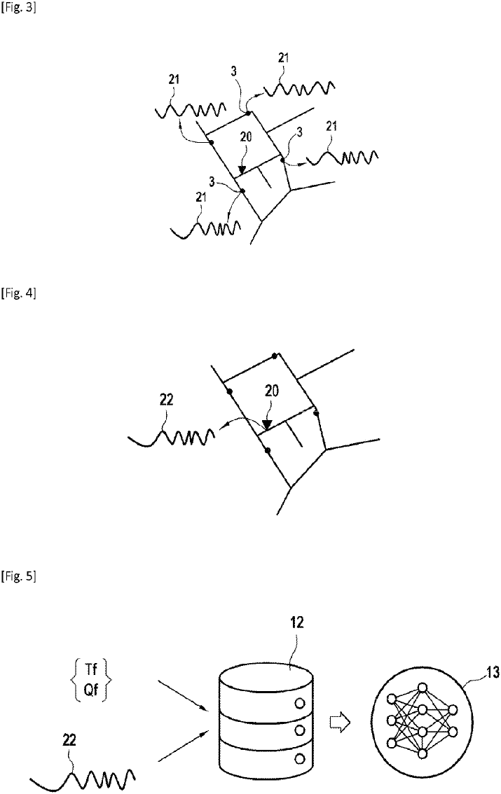

In such a fluid network 1, any leak generates a characteristic noise which propagates along the pipes 2 and which can therefore be detected and recorded by vibro-acoustic sensors 3 such as microphones, geophones, hydrophones or accelerometers. Thus, as represented in FIG. 3, in the presence of a leak 20, the vibro-acoustic sensors 3 of the network 1 each record a signal 21 revealing the presence of the leak 20. However, due to their different positions within the fluid network 1, each sensor 3 records a slightly different signal 21: particularly, the level of the signal is all the more attenuated as the sensor 3 is away from the leak 20; moreover, the shape of the signal can also be altered during the propagation, in particular when passing through certain equipment of the network 1.

Studying this attenuation and/or these alterations then allows more or less accurately locating the leak 20. Moreover, in the present example, the vibro-acoustic sensors 3 are correlative, that is to say they all share a common clock: in this way, it is possible to measure the delay between the different signals 21, which allows, the speed of sound propagation along the pipes 2 being known for a given material recorded in the digital mapping 11, determining the distance separating each sensor 3 from the leak 20. Such correlating sensors then allow locating the leak 20 more easily by cross-checking the data from several sensors 3.

Once the leak 20 is located, it is possible to go on site to excavate it and repair it. On this occasion, it is also possible to determine its type Tf, that is to say to determine whether it is a leak caused by a crack, a tapping or a defective seal, for example at the level of a collar or a connection.

Once the leak 20 is repaired, the calculation unit 14 is capable of automatically determining the flow rate Qf that this leak 20 presented by comparison of the sectorization data before and after the repair.

In addition, as represented in FIG. 4, it is also possible on this occasion to record the vibro-acoustic signal 22 generated by the leak 20 precisely at the level of the leak.

Alternatively or additionally, it is also possible to reconstruct the vibro-acoustic signal during the leak 22 from the signals 21 of the vibro-acoustic sensors 3. Such a reconstruction is carried out by the calculation unit 14 by digital simulation of the acoustic propagation from the geometric and structural data contained in the digital mapping 11 as well as the propagation equations and transfer functions recorded in the memory 15.

The training of the neural network 13 is then represented in FIG. 5. For each leak 20 identified and characterized by an operator, all the data relating to this leak 20 are recorded in the database 12: particularly, the characterization, including the leak type Tf and the leak flow rate Qf, is recorded in association with the vibro-acoustic signal during the leak 22.

Structural data of the pipe 2 having the leak 20 are also recorded in the database 12: these structural data include the material of the pipe, its nominal diameter, its thickness, its depth as well as the surrounding ground material. Contextual repair data, such as the type of backfill used, the flooding state around the leak or a photograph of the leak, can also be recorded in the database 12.

Once a large number of leaks 20 has thus been listed in the database 12, the neural network 13 is applied on the database 12 in order to perform its initial training. Once the initial training is over, the neural network 13 can then be used to automatically characterize new leaks 20.

Concretely, the leak characterization module 10 permanently receives the signals 21 recorded by the vibro-acoustic sensors 3. Insofar as the fluid network 1 can include different types or models of vibro-acoustic sensors 3, all the signals 21 thus recorded are converted, during a standardization step, into a common format using the transfer functions recorded in the memory 15.

In addition, each signal 21 undergoes a qualification step during which it is verified that the signal 21 is not corrupted and has not been made inoperable by an excessive interfering noise such as the passage of a vehicle for example. The signals 21 thus qualified then undergo a cleaning step during which they are filtered in order to remove most of the interference.

Therefore, when a new leak 20 is present in the network 1, the leak characterization module 10 detects the occurrence of a signal representative of a leak in the vibro-acoustic signal 21 of one or several vibro-acoustic sensors 3. The characterization module 10 then carries out the location of the leak 20 then the reconstruction of the vibro-acoustic signal during the leak 22 as described above.

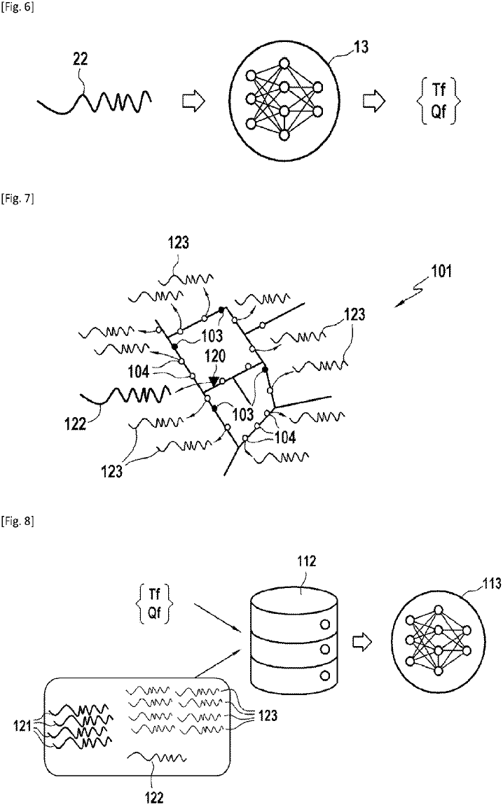

As represented in FIG. 6, the vibro-acoustic signal during the leak 22 is then transmitted at the inlet of the neural network 13: thanks to its training, the neural network 13 is then capable of giving as output the characterization of the leak 20, that is to say its type Tf and/or its flow rate Qf.

The structural data of the pipe 2 having the leak 20, resulting from the digital mapping 11, can also be transmitted at the inlet of the neural network 13 in order to facilitate the characterization and, if necessary, increase its accuracy. In addition, the greater the training of the neural network 13, the finer the accuracy of the characterization: particularly, it is possible to expect an accurate estimation of the flow rate Qf to within 10% or within 5 m³/h.

In order to further increase the ease and accuracy of the characterization, it is also possible to include in the training, then in the input data provided to the neural network 13, all the vibro-acoustic signals 21 recorded by the vibro-acoustic sensors 3, in addition to or instead of the vibro-acoustic signal during the leak 22.

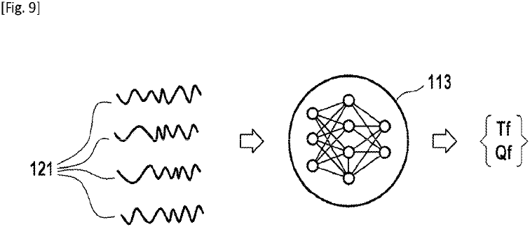

FIGS. 7-9 illustrate another method to further increase the ease and accuracy of the characterization. In this variant, the fluid network 101 includes the same vibro-acoustic sensors 103 as in the first example. However, in addition to these real sensors 103, the fluid network 101 now also includes virtual vibro-acoustic sensors 104.

These virtual vibro-acoustic sensors 104 are positioned in the digital map 11 so as to reduce the distance separating two real or virtual sensors. For example, two virtual sensors 104 can be simulated between two consecutive real sensors 103.

The calculation unit 14 is then capable, for each virtual sensor 104, of simulating the vibro-acoustic signal 123 which would actually be recorded if a real sensor were provided at this location. This simulation is possible from the vibro-acoustic signals 121 of the real sensors 103 provided in the vicinity of the virtual sensor 104 considered, by solving the digital simulation of the acoustic propagation using the propagation equations and transfer functions recorded in the memory 15 of the characterization module 10.

All the real vibro-acoustic signals 121, reconstructed during the leak 122 and simulated 123 from a given leak 120 can then be recorded in the database 112, which increases the amount of data on which the neural network 113 can perform its training.

In addition, in order to enhance the robustness of the training, each signal 121, 122, 123 recorded in the database can undergo a noise-adding step during which noise is added to the signal 121, 122, 123.

Accordingly, when a new leak 120 appears, the neural network 113 is capable of more easily and accurately characterizing the new leak 120, even by providing it as input with only the real vibro-acoustic signals 121 for example. Naturally, it is also possible to provide the neural network 113, in addition to or instead of the real acoustic signals 121, with the signal reconstructed to the source 122 and/or simulated signals 123.

Although the present disclosure has been described with reference to specific exemplary embodiments, it is obvious that modifications and changes can be made to these examples without departing from the general scope of the disclosure as defined by the claims. Particularly, individual characteristics of the different illustrated/mentioned embodiments can be combined in additional embodiments. Accordingly, the description and the drawings should be considered in an illustrative rather than restrictive sense.

It is also obvious that all the characteristics described with reference to a method can be transposed, alone or in combination, to one device, and conversely, all the characteristics described with reference to a device can be transposed, alone or in combination, to one method.

1-15. (canceled)

16. A method for training a statistical learning model intended for the characterization of a leak in a fluid network including a plurality of pipes, wherein the fluid network is equipped with a plurality of vibro-acoustic sensors configured to provide vibro-acoustic signals, the method comprising:
associating, with the construction of a database, at least for a plurality of documented leaks, at least one leak characterization data actually determined among the leak type and the leak flow rate with at least one vibro-acoustic signal obtained directly or indirectly from at least one vibro-acoustic sensor, and
training of the statistical learning model on the thus constructed database.

17. The training method according to claim 16, wherein the fluid network is equipped with at least one flow rate sensor providing sectorization data, and
wherein the training method comprises, for at least one documented leak, a step of determining the leak flow rate using the sectorization data.

18. The training method according to claim 16, wherein the fluid network is provided with a digital mapping comprising at least the geometry of the fluid network and the location of said vibro-acoustic sensors.

19. The training method according to claim 18, comprising, for at least one documented leak, a step of simulating at least one virtual vibro-acoustic sensor having a virtual location recorded in the digital mapping of the fluid network and a simulated vibro-acoustic signal from the actually measured vibro-acoustic signals from the real vibro-acoustic sensors and the geometric data from the digital mapping of the fluid network.

20. The training method according to claim 18, comprising a step of locating the leak from the vibro-acoustic signals from the vibro-acoustic sensors and the geometric data from the digital mapping of the fluid network and, for at least one documented leak, a step of reconstructing the vibro-acoustic signal at the level of the leak from the vibro-acoustic signals from the vibro-acoustic sensors and the geometric data from the digital mapping of the fluid network.

21. The training method according to claim 16, wherein the database comprises, for at least one documented leak, structural data of the pipe at level of the leak.

22. The training method according to claim 16, comprising a standardization step resulting in converting the raw vibro-acoustic signal from at least one vibro-acoustic sensor into a standardized vibro-acoustic signal having a predetermined format.

23. The training method according to claim 16, wherein the statistical learning model is a neural network.

24. A method for characterizing a leak in a fluid network including a plurality of pipes, wherein the fluid network is equipped with a plurality of vibro-acoustic sensors configured to provide vibro-acoustic signals, the method comprising:
receiving, by a statistical learning model, as input at least one vibro-acoustic signal obtained directly or indirectly from at least one vibro-acoustic sensor and providing, from the statistical learning model, as output at least one leak characterization data among the leak type and the leak flow rate, and
wherein the statistical learning model has been trained using a training method according to claim 16.

25. The leak characterization method according to claim 24, wherein the fluid network is provided with a digital mapping comprising at least the geometry of the fluid network and the location of said vibro-acoustic sensors.

26. The characterization method according to claim 25, comprising a step of locating the leak from the vibro-acoustic signals from the vibro-acoustic sensors and the geometric data from the digital mapping of the fluid network and a step of reconstructing the vibro-acoustic signal at the level of the leak from the vibro-acoustic signals from the vibro-acoustic sensors and the geometric data from the digital mapping of the fluid network, wherein the statistical learning model receives as input at least the vibro-acoustic signal reconstructed at the level of the leak.

27. The characterization method according to claim 25, wherein the digital mapping of the fluid network comprises structural data of the fluid network.

28. A module for characterizing a leak in a fluid network, the fluid network being equipped with a plurality of vibro-acoustic sensors configured to provide vibro-acoustic signals, the module comprising:
a statistical learning model, configured to receive as input at least one vibro-acoustic signal obtained directly or indirectly from at least one vibro-acoustic sensor and to provide as output at least one leak characterization data among the leak type and the leak flow rate,
wherein the statistical learning model has been trained using a training method according to claim 16.

29. A fluid network, comprising:
a plurality of vibro-acoustic sensors configured to provide vibro-acoustic signals, and
a characterization module according to claim 28.

30. A computer program comprising instructions for executing the steps of the training method of claim 16 when the program is executed by a computer.

31. A computer program comprising instructions for executing the steps of the characterization method of claim 24 when the program is executed by a computer.
